(19) United States
(12) Patent Application Publication
(10) Pub. No.: US 2008/0036830 A1
(43) Pub. Date: Feb. 14, 2008

(54) INK-JET INK, METHOD FOR PREPARING THE INK-JET INK, INK CARTRIDGE CONTAINING THE INK-JET INK, IMAGE FORMING METHOD USING THE INK-JET INK, AND IMAGE FORMED WITH THE INK-JET INK

(76) Inventors: Yuji NATORI, Numazu-shi (JP); Keishi TANIGUCHI, Susono-shi (JP); Minoru HAKIRI, Numazu-shi (JP); Yasuyuki HOSOGI, Numazu-shi (JP); Shigeo HATADA, Numazu-shi (JP); Shinn HASEGAWA, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/834,059

(22) Filed: Aug. 6, 2007

(30) Foreign Application Priority Data
Aug. 4, 2006 (JP) 2006-212887
Aug. 9, 2006 (JP) 2006-216717

(51) Int. Cl. B41J 2/175; B41J 2/01; C09D 11/02

(52) U.S. Cl. 347/86; 106/31.65; 347/100

(57) ABSTRACT

An ink-jet ink including a pigment a dispersant, a water, a particulate resin (A) dyed with a fluorescent dye and having an average particle diameter of from 50 to 200 nm, and an emulsion of a self-emulsifiable polyurethane; and a method for preparing the ink-jet ink, an ink cartridge containing the ink-jet ink, an image forming method using the ink-jet ink, and an image formed with the ink-jet ink.

### BACKGROUND OF THE INVENTION

1. Field of the Invention

The present invention relates to an ink-jet ink for use in ink-jet printers. In addition, the present invention also relates to a method for preparing the ink-jet ink, an ink cartridge containing the ink-jet ink, an image forming method using the ink-jet ink, and an image formed with the ink-jet ink.

2. Discussion of the Background

An ink in which a water-soluble dye is dissolved in water or a mixture of water and a water-soluble solvent has been mainly used for ink-jet recording methods.

However, there is a problem that an image printed by such a dye-based ink on a recording material has poor water resistance. If water spills on the image, the dye easily smears. There is another problem that the image has poor light resistance. When the image is exposed to light, the color tone tends to change and the image density tends to decrease.

In attempting to solve the above problems of the dye-based ink, a pigment-based ink in which a carbon black or an organic pigment is used instead of dyes is proposed for use in ink-jet recording methods.

An image printed by the pigment-based ink on a recording material has good water resistance. The pigment does not smear even if water spills on the image after the ink is dried.

In addition, the pigment-based ink has better light resistance compared to the dye-based ink because pigment have less reactivity to light compared to dyes.

The pigment-based ink is typically prepared as follows. At first, a mixture including a pigment, a liquid medium, and a dispersant is subjected to a dispersion treatment using a dispersing machine such as a ball mill and a sand mill, to prepare a pigment dispersion liquid. Various additives are optionally added to the pigment dispersion liquid, if desired. Thus, the pigment-based ink is prepared. In view of preventing the occurrence of nozzle clogging of ink-jet printers, and ensuring sharpness, secondary color reproducibility, and transparency of the printed image, pigment particles included in the pigment dispersion liquid need to have a particle diameter of not greater than 200 nm. It is known that when the pigment particles have a particle diameter of not greater than 100 nm, images having better color saturation and transparency can be obtained. It is known that when the pigment particles have a particle diameter of not greater than 50 nm, properties of the ink are close to those of the dye-based ink, and therefore images having better color saturation and transparency can be obtained.

For example, a pigment-based ink in which particles of a quinacridone pigment, which is mainly used as a magenta pigment, are finely dispersed can produce images having good color saturation to some extent. However, these images have poorer color saturation than images printed by a dye-based ink.

In attempting to enhance color saturation of the image produced by a pigment-based ink, published unexamined Japanese Patent Application No. (hereinafter referred to as JP-A) 10-130558 discloses an ink including a fluorescent pigment in an amount of from 0.1 to 3% by weight based on total amount of the ink. It is disclosed therein that the ink can increase the color saturation in an amount of about 5%.

However, the fluorescent pigment dispersed together with a typical pigment has very unstable dispersibility in the ink. When an image is printed by an ink-jet printer using such an ink, image bending is observed in the resultant image. When such an ink is set in a piezo ink-jet printer and left for one month, the ink becomes clogged and cannot be supplied to print an image.

In attempting to enhance color saturation of the image produced by the magenta pigment-based ink, JP-A 10-298467 discloses an ink including an aqueous suspension of polymer particles to which a colorant mixture, in which a colorant having no fluorescence and a colorant having fluorescence are mixed at a specific weight ratio, is adsorbed.

It is described therein that such an ink improves water resistance and printing qualities, such as printing density, color tone, and color saturation, of the printed image. While the results showing the improvements in printing density and lightness of color are disclosed in Examples, no mention is made of the improvement in color saturation in Examples. Therefore, it is not clear whether the ink disclosed therein improves color saturation or not.

In addition, it is a natural result that the inks disclosed in the Examples produce images having higher printing density than those disclosed in Comparative Examples, because the amount (i.e., adsorption amount) of the colorant mixture adsorbed to the polymer particles of Examples are larger than those of Comparative Examples.

Therefore, it should be considered that the claim is not proved that the ink including an aqueous suspension of polymer particles to which a colorant mixture, in which a colorant having no fluorescence and a colorant having fluorescence are mixed at a specific weight ratio, is adsorbed improves color saturation and printing density of the printed image.

The color tone of an image can be tuned by varying the ink composition (e.g., pigment density, added amount of penetrant or humectant) or the kind of the ink receptor (e.g., paper). When the color tone of the above ink is tuned, aqueous suspensions of polymer particles to each of which a colorant mixture, in which a colorant having no fluorescence and a colorant having fluorescence are mixed at various ratio, is adsorbed have to be prepared. Among these aqueous suspensions, the best one is selected. This method is very complicated and not economical.

### SUMMARY OF THE INVENTION

Accordingly, an object of the present invention is to provide an ink-jet ink having a good combination of the following properties:

(1) producing images with good color saturation, image density and water resistance, and without image bending;

(2) easy to control the color tone;

(3) produced at low cost; and

(4) stably discharged from the nozzle.

Another object of the present invention is to provide a method for preparing the ink-jet ink, an ink cartridge containing the ink-jet ink, an image forming method using the ink-jet ink, and an image formed with the ink-jet ink.

These and other objects of the present invention, either individually or in combinations thereof, as hereinafter will become more readily apparent can be attained by an ink-jet ink, comprising:

a pigment;

a dispersant;

a water;

a particulate resin (A) dyed with a fluorescent dye and having an average particle diameter of from 50 to 200 nm; and

an emulsion of a self-emulsifiable polyurethane; and a method for preparing the ink-jet ink, an ink cartridge containing the ink-jet ink, an image forming method using the ink-jet ink, and an image formed with the ink-jet ink.

### DETAILED DESCRIPTION OF THE INVENTION

Generally, the present invention provides an ink-jet ink comprising a pigment, a dispersant, a water, a particulate resin (A) dyed with a fluorescent dye and having an average particle diameter of from 50 to 200 nm, and an emulsion of a self-emulsifiable polyurethane.

The particulate resin (A) has an average particle diameter of from 50 to 200 nm. When the average particle diameter is too small, the fluorescence intensity decreases, resulting in deterioration of color saturation of the resultant image. When the average particle diameter is too large, the ink cannot be stably discharged from the nozzle.

Further, the particulate resin (A) preferably has an average particle diameter of from 70 to 150 nm. In this case, the occurrence of diffuse reflection by the pigment particles can be prevented, and therefore images having more uniform density can be provided.

The particulate resin (A) can be prepared by known methods such as a method disclosed in JP-A 2001-181544, the content of which is hereby incorporated by reference.

The method for preparing an ink-jet ink of the present invention comprises:

adding an aqueous emulsion of a self-emulsifiable polyurethane to a pigment dispersion comprising a pigment, a dispersant, and a water, to prepare a first mixture;

agitating the first mixture (preferably for 10 minutes or more);

adding a particulate resin (A) dyed with a fluorescent dye and having an average particle diameter of from 50 to 200 nm to the first mixture, to prepare a second mixture;

agitating the second mixture (preferably for 10 minutes or more); and

optionally adding an additive selected from the group consisting of a humectant, a surfactant, an antifoamer, a smear prevention agent, a pH buffering agent, and an antiseptic agent.

The pigment dispersion is prepared as follows:

pre-mixing the pigment, the water, and the dispersant; and

subjecting the mixture to a dispersing treatment using a disperser such as a sand mill and a DYNO-MILL.

When the aqueous solution of a self-emulsifiable polyurethane is added to the thus prepared pigment dispersion in the above-mentioned order, the pigment is prevented from aggregating and is stably dispersed. The resultant ink has stable viscosity.

When the ink is not prepared by the above method, the pigment is unstably dispersed in the ink liquid. When the ink is prepared by the above method, it is considered that the polyurethane adsorbs to the pigment, and then the particulate resin (A) dyed with a fluorescent dye further adsorbs to the polyurethane. Therefore, the particulate resin (A) dyed with a fluorescent dye and the pigment are prevented from aggregating and stably dispersed.

The ink-jet ink of the present invention preferably comprises the particulate resin (A) dyed with a fluorescent dye in an amount of from 0.1 to 40.0% by weight, and more preferably from 0.5 to 25.0% by weight, on a solid basis. When the amount is too small, color saturation of the resultant image cannot satisfactorily increase. When the amount is too large, stability and color tone of the ink deteriorate. When the amount is from 0.1 to 40.0% by weight, the pigment particles are much more stably dispersed in the ink. Therefore, the droplets of the discharged ink are uniformly formed, resulting in improved color saturation of the resultant image.

The self-emulsifiable polyurethane for use in the ink-jet ink of the present invention is preferably anionic.

Emulsions of a polyurethane resin are classified into an emulsion in which a typical polyurethane resin, which is relatively hydrophilic, is emulsified using an emulsifier; and a self-emulsifiable emulsion in which a resin to which a functional group having an emulsifying function is introduced by means of copolymerization etc. is self-emulsified. Among these, an anionic self-emulsifiable polyurethane emulsion constantly has dispersing stability when used in combination with a pigment, a dispersant, etc.

From the aspect of adherence and dispersing stability of the pigment, the polyurethane resin is preferably an ether type than a polyester type or a polycarbonate type.

When the self-emulsifiable polyurethane is not anionic, stability of the ink liquid deteriorates.

The ink-jet ink of the present invention preferably includes the polyurethane in an amount of from 0.01 to 7% by weight on a solid basis. When the amount is too small, too small amount of the polyurethane adsorbs to the pigment. Therefore, the pigment particles tend to aggregate, resulting in increase of viscosity of the ink. When the amount is too large, the polyurethane particles tends to adhere with each other, resulting in deterioration of stability of the ink.

The polyurethane for use in the ink-jet ink of the present invention preferably has an average particle diameter of not greater than 50 nm. When the average particle diameter is too large, the polyurethane particles tend to precipitate in the ink.

The pigment for use in the ink-jet ink of the present invention preferably has an average particle diameter of from 10 to 200 nm, and more preferably from 20 to 100 nm. When the average particle diameter is too small, preservation stability of the ink deteriorates. In addition, it takes a long time to prepare a pigment having too small an average particle diameter. When the average particle diameter is too large, nozzle clogging tends to occur, resulting in deterioration of discharging stability of the ink.

The ink-jet ink of the present invention preferably includes the pigment in an amount of from 1 to 15% by weight, and more preferably from 3 to 12% by weight. When the amount is too small, the resultant image density deteriorates. When the amount is too large, nozzle clogging tends to occur, resulting in deterioration of discharging stability of the ink.

In the present invention, the average particle diameter of the pigment can be measured by MICROTRAC® UPA (from Nikkiso Co., Ltd.).

The dispersing agent for use in the ink-jet ink of the present invention is preferably a surfactant. In this case, the ink is prevented from bubbling, and produces images having high color saturation.

As the surfactant, anionic, nonionic, cationic, and ampholytic surfactants can be used.

Specific examples of the anionic surfactants include, but are not limited to, fatty acid salts, alkyl sulfates, alkyl aryl sulfonates, alkyl naphthalene sulfonates, dialkyl sulfonates, dialkyl sulfosuccinates, alkyl diaryl ether disulfonate, alkyl phosphates, polyoxyethylene alkyl ether sulfates, polyoxyethylene alkyl aryl ether sulfates, naphthalene sulfonic acid formalin condensates, polyoxyethylene alkyl phosphates, glycerol borate fatty acid esters, and polyoxyethylene glycerol fatty acid esters.

Specific examples of the nonionic surfactants include, but are not limited to, polyoxyethylene alkyl ethers, polyoxyethylene alkyl aryl ethers, polyoxyethylene oxypropylene block copolymers, sorbitan fatty acid esters, polyoxyethylene sorbitan fatty acid esters, polyoxyethylene sorbitol fatty acid esters, glycerin fatty acid esters, polyoxyethylene fatty acid esters, polyoxyethylene alkylamine, fluorine surfactants, and silicon surfactants.

Specific examples of the cationic surfactants include, but are not limited to, alkylamine salts, quaternary ammonium salts, alkyl pyridinium salts, and alkyl imidazolium salts.

Specific examples of the ampholytic surfactants include, but are not limited to, alkyl betaine, alkylamine oxide, and phosphatidylcholine.

Among these, nonionic surfactants are preferably used. In particular, the compound having the following formula (I) is more preferably used, and POE (n=40) β-naphthyl ether is most preferably used:

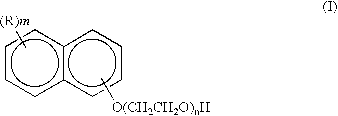

wherein R represents an alkyl, aryl, or an aralkyl group having 1 to 20 carbon atoms, m represents an integer of from 0 to 7, and n represents an integer of from 20 to 200.

The ink-jet ink of the present invention may include an alkanediol and/or an acetylene glycol surfactant. In this case, the ink is prevented from bubbling, and produces images having high color saturation.

The ink-jet ink of the present invention preferably includes the alkanediol in an amount of from 0.2 to 15% by weight, and more preferably from 0.3 to 10% by weight. When the amount is too small, color saturation of the resultant image deteriorates. When the amount is too large, preservation stability of the ink deteriorates.

Specific examples of the alkanediols include, but are not limited to, 1,2-hexanediol, 1,2-heptanediol, 1,3-heptanediol, 2-methyl-1,3-hexanediol, 2-butyl-2-ethyl-propanediol, and 2-ethyl-1,3-hexanediol.

When the ink-jet ink of the present invention includes the acetylene glycol surfactant, color saturation of the resultant image much more increases.

The ink-jet ink of the present invention preferably includes the acetylene glycol surfactant in an amount of from 0.1 to 12% by weight, and more preferably from 0.1 to 5% by weight.

Specific examples of the acetylene glycol surfactants include, but are not limited to, 2,4,7,9-tetramethyl-5-decin-4,7-diol, 3,6-dimethyl-4-octine-3,6-diol, and 3,5-dimethyl-1-hexin-3-ol. Specific examples of useable commercially available acetylene glycol surfactants include, but are not limited to, SURFYNOL® 104, 82, 465, 485, and TG (from Air Products and Chemicals, Inc.); and OLFINE® STG and E1010 (from Nissin Chemical Industry Co., Ltd.).

As the fluorescent dye for use in the present invention, basic dyes (including cathilon dyes), direct dyes, and fluorescent brightening dyes can be used, but is not limited thereto. In particular, a daylight fluorescent dye, a mixture of two or more fluorescent dyes, and a mixture of a daylight fluorescent dye and a normal dye (having no fluorescence) are preferably used.

Specific examples of the fluorescent dyes include, but are not limited to, C. I. (Color Index) Basic Yellow 1, Basic Yellow 40, Basic Red 1, Basic Red 13, Basic Violet 7, Basic Violet 10, Basic Orange 22, Basic Blue 7, Basic Green 1, Direct Yellow 85, Direct Orange 8, Direct Red 9, Direct Blue 22, Direct Green 6, Fluorescent Brightening Agent 55, Fluorescent Brightening Whitex WS52, Fluorescent 162, and Fluorescent 112. Among these, Basic Yellow 40, Basic Red 1, Basic Violet 10, and Fluorescent Brightening Whitex WS 52 are preferably used.

A particulate resin is dyed with the above dye at the same time or after emulsion-polymerization. The emulsion polymerization is preferably performed under atmospheric pressure or increased pressure at a temperature of 40 to 110° C., and agitation for 1 to 5 hours. The resultant polymer preferably includes the dye in an amount of from 0.01 to 10 parts by weight, and more preferably from 0.1 to 5 parts by weight based on 100 parts by weight of the polymer, on a solid basis.

The ink-jet ink of the present invention includes a pigment as a colorant.

Specific examples of the pigments for use in magenta inks include, but are not limited to, C. I. Pigment Red 5, 7, 12, 48 (Ca), 48 (Mn), 57 (Ca), 57:1, 112, 122, 123, 146, 168, 176, 184, 185, 202, and 209, and Pigment Violet 19.

In the present invention, pigments which can be stably dispersed without a dispersant such as a self-dispersible pigment (i.e., surface-treated pigment), the surface of which has a water-dispersible group, and a capsulated pigment (i.e., water-dispersible polymer containing pigment), the surface of which is covered with a polymer; and pigments which can be stably dispersed with a dispersant can be used.

The ink-jet ink of the present invention optionally includes a pH buffering agent.

Specific examples of the pH buffering agents include, but are not limited to, aminoethanesulfonic acid, 2-amoinoethanesulfonic acid, 2-aminoethyl sulfate, N-acetyl-L-cysteine, catechol, pyrogallol, o-phenolsulfonic acid, p-phenolsulfonic acid, phloroglucinol, resorcinol, asparagine, arginine, L-allothreonine, ornithine, ornithine hydrochloride, reduced glutathione, oxidized glutathione, glutamine, cystine, cysteine, 3,4-dihydroxyphenylalanine, L-serine, DL-serine, tyrosine, tryptophan, L-threonine, DL-threonine, histidine, phenylalanine, homocystein, DL-methionine, L-methionine, lysine, lysine hydrochloride, 4-aminopyridine, pyridoxal, pyridoxine hydrochloride, morpholine, inosine, uracil, guanine, guanosine, hypoxanthine, purine, N,N-bis(2-hydroxyethyl)-2-aminoethanesulfonic acid, 3-morpholinopropanesulfonic acid, [N-tris(hydroxymethyl)methyl-2-amino]ethanesulfonic acid, N-2-hydroxyethylpiperazine-N′-2-ethanesulfonic acid, piperazine-N—N′-bis(2-hydroxypropane)-3-sulfonic acid, 3-[N-(tris-hydroxymethyl)methylamino]-2-hydroxypropanesulfonic acid, 3-[N,N-bis(2-hydroxyethyl)amino]-2-hydroxypropanesulfonic acid, N-2′-hydroxyethylpiperazine-N-2-hydroxypropane-3-sulfonic acid, N-2-hydroxyethylpiperazine-N′-2-ethanesulfonic acid, tris(hydroxymethyl)aminomethane, N—[tris(hydroxymethyl)methyl]glycine, glycylglycine, N,N-di(2-hydroxyethyl)glycine, N-[tris(hydroxymethyl)methyl]-3-aminopropanesulfonic acid, diethanolamine, ethanolamine, 2-amino-2-methyl-1,3-propanediol, 2-amino-2-ethyl-1,3-propanediol, 3-[(1,1-dimethyl-2-hydroxyethyl)amino]-2-hydroxypropanesulfonic acid, 2-cyclohexylaminoethanesulfonic acid, N-cyclohexyl-2-hydroxy-3-aminopropanesulfonic acid, and 3-cyclohexylaminopropanesulfonic acid. Among these, 3-[(1,1-dimethyl-2-hydroxyethyl)amino]-2-hydroxypropanesulfonic acid, 2-cyclohexylaminoethanesulfonic acid, N-cyclohexyl-2-hydroxy-3-aminopropanesulfonic acid, and 3-cyclohexylaminopropanesulfonic acid are preferably used.

The ink-jet ink of the present invention preferably includes the pH buffering agent in an amount of from 0.001 to 10% by weight, more preferably from 0.005 to 5% by weight, and much more preferably from 0.05 to 2% by weight. When the amount is too small, the variations in pH cannot be satisfactorily prevented. When the amount is too large, viscosity of the ink is too large.

The present invention provides another ink-jet ink including a particulate resin (A′) dyed with a fluorescent dye and having an average particle diameter of from 50 to 130 nm and a quinacridone pigment (B) having an average particle diameter of from 50 to 130 nm, wherein the particulate resin (A′) has a color tone selected from yellow, yellow-orange, orange, red-orange, red, pink, cerise, rose, magenta, and a mixture thereof.

When the particulate resin (A′) does not have a color tone selected from yellow, yellow-orange, orange, red-orange, red, pink, cerise, rose, magenta, and a mixture thereof, the resultant image has a dirty color even if the image density is high. In this case, magenta images having high color saturation cannot be obtained. In particular, the particulate resin (A′) preferably has a color tone having a wavelength of 580 nm or more, and more preferably from 590 to 650 nm.

The particulate resin (A′) preferably has an average particle diameter of from 50 to 130 nm. When the average particle diameter is too small, the fluorescence intensity decreases, resulting in deterioration of color saturation of the resultant image. When the average particle diameter is too large, the ink cannot be stably discharged from the nozzle.

The quinacridone pigment (B) preferably has an average particle diameter of from 50 to 130 nm. When the average particle diameter is too small, it is difficult to disperse the pigment and preservation stability of the ink deteriorates. When the average particle diameter is too large, nozzle clogging tends to occur, resulting in deterioration of discharging stability of the ink.

The quinacridone pigment (B) can be obtained by dispersing a quinacridone pigment such as quinacridone, dimethylquinacridone, and dichloroquinacridone, by a typical method. These quinacridone pigments are low in cost. In addition, the color tone of the ink can be easily controlled by varying the added amounts of the particulate resin (A′) and the quinacridone pigment (B).

In the ink-jet ink of the present invention, the weight ratio (A′/B) of the particulate resin (A′) to the quinacridone pigment (B) is preferably from 1/2 to 8/1. When the ratio of the quinacridone pigment (B) is too large, color saturation of the resultant image cannot satisfactorily increase. When the ratio of the particulate resin (A′) is too large, the resultant image density deteriorates and the magenta color tone is unnatural because the fluorescence is too strong.

The particulate resin (A′) preferably has a particle diameter distribution such that a standard deviation is not greater than 40 nm. When the standard deviation is too large, the number of coarse particles increases, resulting in deterioration of discharging stability of the ink.

The particulate resin (A′) preferably has at least one monomer unit selected from styrene, acrylonitrile, acrylic acid, and methacrylic acid. A polymer including the above units has good dyeing property, and therefore the resultant image has high image density.

The quinacridone pigment (B) is at least one member selected from quinacridone, dimethylquinacridone, and dichloroquinacridone. Other quinacridone pigments are high in cost, and cannot provide good magenta color tone.

The ink-jet ink of the present invention preferably includes the particulate resin (A′) and the quinacridone pigment (B) in a total amount of from 5 to 20% by weight. When the total amount is too small, the resultant image density is low. When the total amount is too large, nozzle clogging tends to occur.

In the ink-jet ink of the present invention, the quinacridone pigment (B) is preferably dispersed by a dispersant. In this case, the ink can be prepared at a low cost. A self-dispersible pigment (i.e., surface-treated pigment), the surface of which has a water-dispersible group, which can be stably dispersed without a dispersant is high in cost.

In one embodiment of the ink-jet ink of the present invention, the quinacridone pigment (B) is preferably dispersed by a nonionic surfactant. The nonionic surfactant is low in cost. In addition, an ink including the nonionic surfactant has good preservation stability when used in combination with various additives.

In a further embodiment of the ink-jet ink of the present invention, the quinacridone pigment (B) is preferably dispersed by a POE naphthyl ether, and more preferably that including EO in an amount of from 12 to 60 mol. The POE naphthyl ether has a naphthyl group which strongly binds to the quinacridone pigment. Therefore, dispersing stability of the quinacridone increases. When the amount of EO is too small, dispersing stability of the pigment decreases. When the amount of EO is too large, viscosity of the ink increases.

In another embodiment of the ink-jet ink of the present invention, the quinacridone pigment (B) is preferably dispersed by an anionic surfactant. The anionic surfactant is low in cost. In addition, an ink including the anionic surfactant has good dispersing stability.

In a further preferred embodiment of the ink-jet ink of the present invention, the quinacridone pigment (B) is preferably dispersed by an alkaline salt of a POE naphthyl ether phosphate, and more preferably that including EO in an amount of from 5 to 60 mol and the alkaline is at least one member selected from Li, Na, and K.

The alkaline salt of a POE naphthyl ether phosphate has a naphthyl group which strongly binds to the quinacridone pigment. Therefore, dispersing stability of the quinacridone increases. In addition, the alkaline salt part prevents the dispersed pigment particles from aggregating, resulting in increasing dispersing stability of the pigment.

When the amount of EO is too small, dispersing stability of the pigment decreases. When the amount of EO is too large, viscosity of the ink increases.

When the alkali metal is at least one member selected from Li, Na, and K, the ink can be prepared at a low cost. In addition, an ink including such an alkaline salt has good preservation stability when used in combination with various additives.

In the ink-jet ink of the present invention, the weight ratio (B/dispersant) of the quinacridone pigment (B) to the dispersant is preferably from 1/1 to 1/0.1. When the weight ratio (B/dispersant) is too large, viscosity of the ink increases and preservation stability of the ink deteriorates. When the weight ratio (B/dispersant) is too small, dispersing stability deteriorates.

The particulate resin (A′) can be prepared by known methods such as a method disclosed in JP-A 2001-181544, the contents of which are hereby incorporated by reference.

The quinacridone pigment (B) can be prepared by subjecting a quinacridone pigment to a dispersion treatment using a surfactant disclosed in the present invention. In particular, the quinacridone pigment (B) can be prepared as follows:

pre-mixing a quinacridone pigment, water, and a dispersant; and

subjecting the mixture to a dispersing treatment using a disperser such as a sand mill and a DYNO-MILL until the resultant particles have a desired average particle diameter.

The thus prepared particulate resin (A′) and quinacridone pigment (B) are mixed at a specific ratio, and then water and/or a water-soluble organic solvent, optionally together with a surfactant, an antiseptic agent, etc., are added thereto. Thus, an ink is prepared.

The water for use in the ink-jet ink of the present invention includes pure water such as ion-exchanged water, ultrafiltrated water, reverse osmosis water, and distilled water; and ultrapure water.

Water sterilized by irradiation with ultraviolet rays, the addition of hydrogen peroxide, etc. can also be used. An ink using such sterilized water is prevented from generating molds and bacteria when preserved for a long time.

The ink-jet ink of the present invention may include a water-soluble organic solvent.

Specific examples of the water-soluble organic solvents include, but are not limited to, alkyl alcohols having 1 to 4 carbon atoms (e.g., methyl alcohol, ethyl alcohol, n-propyl alcohol, isopropyl alcohol, n-butyl alcohol, sec-butyl alcohol, tert-butyl alcohol), amides (e.g., dimethylformamide, dimethylacetamide), ketones and ketone alcohols (e.g., acetone, methyl ethyl ketone, diacetone alcohol), ethers (e.g., tetrahydrofuran, dioxane), polyols (e.g., ethylene glycol, propylene glycol, 1,2-propanediol, 1,2-butanediol, 1,3-bitanediol, 3-methyl-1,3-butanediol, 1,4-butanediol, diethylene glycol, triethylene glycol, 1,2,6-hexanetriol, thiodiglycol, hexylene glycol, glycerin), polyalkylene glycol (e.g., polyethylene glycol, polypropylene glycol), lower alkyl ethers of polyols (e.g., ethylene glycol monomethyl (or ethyl)ether, diethylene glycol methyl (or ethyl)ether, triethylene glycol monomethyl (or ethyl)ether), alkanolamines (e.g., monoethanolamine, diethanolamine, triethanolamine), N-methyl-2-pyrrolidone, 2-pyrrolidone, and 1,3-dimethyl-2-imidazolidinone.

From an environmental viewpoint, the ink-jet ink preferably includes a water-soluble organic solvent in an amount of not greater than 50%.

Further, the ink-jet ink of the present invention may optionally include a pH buffering agent, an antiseptic agent, a resin, etc., if desired.

In the present invention, the average particle diameter and the standard deviation thereof can be measured by MICROTAC® UPA (from Nikkiso Co., Ltd.).

The ink-jet ink of the present invention can be used for printing methods such as an ink-jet printer having a continuous injection type or on-demand type recording head. Specific examples of the on-demand types include, but are not limited to, piezo type, thermal ink-jet type, and electrostatic type.

Embodiments of an ink cartridge containing the ink-jet ink of the present invention, an ink-jet printer configured to discharge the ink-jet ink of the present invention, and an image forming method using such an ink-jet printer can be easily obtained referring to a related art of the present technical field such as JP-A 2000-198958, for example.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

A 2-liter flask equipped with a condenser, a thermometer, a 500-ml separating funnel for charging monomers, and a stirrer are set in a water bath.

The flask is charged with 440 ml of water, 8.5 g of sodium dodecylbenzenesulfonate, and 7 g of a nonionic surfactant EMULGEN® LS-110 (from Kao Corporation), and then heated so that the inner temperature was 80° C. Further, 2.1 g of a potassium persulfate are added thereto. A monomer mixture liquid in which 140 g of acrylonitrile, 120 g of styrene, and 13 g of acrylic acid are mixed is dropped therein from the separating funnel over a period of 3 hours while agitating. The mixture is subjected to a polymerization for 4 hours.

Next, 200 g of water, 0.3 g of rhodamine F3B (BASONYL® RED 560 from BASF Japan Ltd.), 2.0 g of a rhodamine F4G (BASONYL® RED 485 from BASF Japan Ltd.), and 17.5 g of a special polycarboxylic acid-based polymer surfactant (DEMOL® EP from Koa Corporation) are added to the above product while agitating at room temperature. The mixture is uniformly mixed, and then gradually heated. The resultant polymer is dyed for 1 hour at 85° C. Thus, a dispersion of a pink particulate resin having an average particle diameter of 60 nm is prepared. The dispersion is controlled to have a solid content of 40% by weight. Thus, a fluorescent particulate resin dispersion (F) is prepared.

Next, the following components are pre-mixed.

| | |
|---|---|
| Pigment Red 122 | 151 parts |
| (IRGAPHOR MAGENTA DMQ from Ciba Specialty | |
| Chemicals) | |
| POE (n = 40) β-naphthyl ether | 57 parts |
| Distilled water | 796 parts |

The mixture is subjected to a circular dispersion treatment using a disk-type bead mill (KDL from Shinmaru Enterprise Corporation, media: zirconia ball having a diameter of 0.3 mm) for 20 hours. Thus, a colorant dispersion (A) having an average particle diameter of 63.5 nm is prepared.

Next, 10.0 parts of a self-emulsifiable anionic polyether-based polyurethane emulsion (TAKELAC® W-5025 from Mitsui Takeda Chemicals Inc., having a solid content of 30.0% and an average particle diameter of 20.3 nm) are added to 34.0 parts of the colorant dispersion (A), and then the mixture is agitated for 30 minutes. Thus, a colorant dispersion (B) is prepared.

Next, 30.0 parts of the fluorescent particulate resin dispersion (F) are added to the 44.0 parts of the colorant dispersion (B), and then the mixture is agitated for 30 minutes. Thus, a colorant dispersion (C) is prepared.

Next, the following components are added to the colorant dispersion (C) and agitated for 30 minutes.

| | |
|---|---|
| Glycerin | 5.0 parts |
| Diethylene glycol | 15.0 parts |
| 1-Amino-2-ethyl-2,3-propanediol | 2.0 parts |
| Distilled water | 4.0 parts |

The mixture is filtered with a membrane filter with pores having a diameter of 0.8 μm, and then vacuum degassed.

Thus an ink (1) is prepared.

### Example 2

The procedure for preparing the ink in Example 1 is repeated except that the amounts of the self-emulsifiable anionic polyether-based polyurethane emulsion (TAKELAC® W-5025 from Mitsui Takeda Chemicals Inc.) are changed to 14.0 parts and the distilled water is changed to 0 parts.

Thus, an ink (2) is prepared.

### Example 3

The procedure for preparing the ink in Example 1 is repeated except that 3 parts of 2-ethyl-1,3-hexanediol are further added and the amount of the distilled water is changed to 8.3 parts.

Thus, an ink (3) is prepared.

### Example 4

The procedure for preparing the ink in Example 1 is repeated except that 0.1 parts of an acetylene glycol-based surfactant (OLFINE® STG from Nissin Chemical Industry Co., Ltd.) are further added and the amount of the distilled water is changed to 11.2 parts.

Thus, an ink (4) is prepared.

### Example 5

The procedure for preparing the ink in Example 1 is repeated except that 3 parts of 2-ethyl-1,3-hexanediol and 0.1 parts of an acetylene glycol-based surfactant (OLFINE® STG from Nissin Chemical Industry Co., Ltd.) are further added and the amount of the distilled water is changed to 11.2 parts.

Thus, an ink (5) is prepared.

### Comparative Example 1

The procedure for preparing the ink in Example is repeated except that 10.0 parts of the self-emulsifiable anionic polyether-based polyurethane emulsion (TAKELAC® W-5025 from Mitsui Takeda Chemicals Inc.) are replaced with 10.0 parts of distilled water.

Thus, a comparative ink (C1) is prepared.

### Comparative Example 2

The procedure for preparing the ink in Example 1 is repeated except that 10.0 parts of the self-emulsifiable anionic polyether-based polyurethane emulsion (TAKELAC® W-5025 from Mitsui Takeda Chemicals Inc.) are replaced with 10.0 parts of Johnson Polymer JONCRYL® 74J.

Thus, a comparative ink (C2) is prepared.

### Comparative Example 3

The procedure for preparing the ink in Example 1 is repeated except that the pink particulate resin having an average particle diameter of 60 nm is replaced with that having an average particle diameter of 500 nm.

Thus, a comparative ink (C3) is prepared.

### Comparative Example 4

The procedure for preparing the ink in Example 1 is repeated except that the dispersion of a pink particulate resin is controlled to have a solid content of 0.005% by weight.

Thus, a comparative ink (C4) is prepared.

### Evaluation 1

Each of the inks (1) to (5) and (C1) to (C4) prepared above is set in a piezo ink-jet printer EM-930C (from Seiko Epson Corporation) and a thermal ink-jet printer DESKJET 880C (from Hewlett-Packard Development Company, LP), respectively, and images are printed on plain paper (X-4024) and gloss paper (a gloss photo paper from Seiko Epson Corporation).

The image density and color saturation of the image printed on the plain paper by the piezo ink-jet printer EM-930C is measured with an X-RITE densitometer. The color saturation is defined as a distance between the origin point and a chromaticity of a solid image measured with the X-RITE densitometer in the chromaticity diagram.

Next, a test pattern of a solid image having an image proportion of 5% is printed on 200 sheets of A4-size plain paper by the piezo ink-jet printer EM-930C and the thermal ink-jet printer DESKJET 880C, respectively. The 200^{th} solid image is observed with a loupe to evaluate the number of white lines and low-density lines caused by image bending.

On the other hand, each of the inks prepared above is set in a piezo ink-jet printer EM-930C and left for 1 month so as to evaluate whether or not ink clogging occurs.

The evaluation results are shown in Table 1.

TABLE 1

| | Initial Stage | | | | |
|---|---|---|---|---|---|
| | | | Number of Image | | 1 Month |
| | | | Bending | | Later |
| | Color | Image | | DESKJET | Ink |
| | Saturation | Density | EM-930C | 880C | Clogging |
| Ex. 1 | 64.30 | 1.05 | 0 | 0 | No |
| Ex. 2 | 64.10 | 1.06 | 0 | 0 | No |
| Ex. 3 | 64.30 | 1.03 | 0 | 0 | No |
| Ex. 4 | 64.20 | 1.05 | 0 | 0 | No |
| Ex. 5 | 64.10 | 1.04 | 0 | 0 | No |
| Comp. | 62.15 | 0.89 | 2 | 1 | Yes |
| Ex. 1 | | | | | |
| Comp. | 63.00 | 0.85 | 3 | 4 | Yes |
| Ex. 2 | | | | | |
| Comp. | 63.20 | 1.01 | 6 | 5 | No |
| Ex. 3 | | | | | |
| Comp. | 52.70 | 0.85 | 0 | 0 | No |
| Ex. 4 | | | | | |

### Example 6

A 2-liter flask equipped with a condensers a thermometer, a 500-ml separating funnel for charging monomers, and a stirrer were set in a water bath.

The flask is charged with 440 ml of water, 8.5 g of sodium dodecylbenzenesulfonate, and 7 g of a nonionic surfactant EMULGEN® LS-110 (from Kao Corporation), and then heated so that the inner temperature is 80° C. Further, 2.1 g of a potassium persulfate are added thereto. A monomer mixture liquid in which 140 g of acrylonitrile, 120 g of styrene, and 13 g of acrylic acid are mixed is dropped therein from the separating funnel over a period of 3 hours while agitating. The mixture is subjected to a polymerization for 4 hours.

Next, 200 g of water, 0.3 g of rhodamine F3B (BASONYL® RED 560 from BASF Japan Ltd.),2.0 g of a rhodamine F4G (BASONYL® RED 485 from BASF Japan Ltd.), and 17.5 g of a special polycarboxylic acid-based polymer surfactant (DEMOL® EP from Koa Corporation) are added to the above product while agitating at room temperature. The mixture is uniformly mixed, and then gradually heated. The resultant polymer is dyed for 1 hour at 85° C. Thus, a dispersion of a pink particulate resin having an average particle diameter of 58 nm and a standard deviation of 31 nm is prepared. The dispersion is controlled to have a solid content of 40% by weight. Thus, a fluorescent particulate resin dispersion (f1) is prepared.

Next, the following components are pre-mixed.

| | |
|---|---|
| Pigment Red 122 (dimethylquinacridone) | 150 parts |
| (IRGAPHOR MAGENTA DMQ from Ciba Specialty | |
| Chemicals) | |
| POE (n = 40) β-naphthyl ether | 37.5 parts |
| Distilled water | 812.5 parts |

The mixture is subjected to a circular dispersion treatment using a disk-type bead mill (KDL from Shinmaru Enterprise Corporation, media: zirconia ball having a diameter of 0.3 mm) for 20 hours. Thus, a colorant dispersion (a) having an average particle diameter of 63.5 nm is prepared.

The following components are mixed and agitated for 30 minutes.

| | |
|---|---|
| Fluorescent particulate resin dispersion (f1) | 30 parts |
| Colorant dispersion (a) | 33.3 parts |
| Glycerin | 20 parts |
| 2-Ethyl-1,3-hexanediol | 2 parts |
| PEG fluorinated alkyl monoether | 2 parts |
| (ZONYL FS 300 from DuPont) | |
| 1-Amino-2-ethyl-2,3-propanediol | 1 parts |
| Distilled water | 11.7 parts |

The mixture is filtered with a membrane filter with pores having a diameter of 0.8 μm, and then vacuum degassed.

Thus an ink (6) is prepared.

### Example 7

The procedure for preparing the fluorescent particulate resin dispersion (f1) in Example 6 is repeated except that 0.3 g of rhodamine F3B (BASONYL® RED 560 from BASF Japan Ltd.) and 2.0 g of a rhodamine F4G (BASONYL® RED 485 from BASF Japan Ltd.) are replaced with 20 g of Basic Yellow 40 (KAYACRYL BRILLIANT YELLOW F2G from Nippon Kayaku Co., Ltd.), and the amount of the special polycarboxylic acid-based polymer surfactant (DEMOL® EP from Koa Corporation) is changed to 21 g. Thus, a dispersion of a yellow particulate resin having an average particle diameter of 122 nm and a standard deviation of 38 nm is prepared. The dispersion is controlled to have a solid content of 40% by weight. Thus, a fluorescent particulate resin dispersion (f2) is prepared.

The following components are mixed and agitated for 30 minutes.

| | |
|---|---|
| Fluorescent particulate resin dispersion (f2) | 8 parts |
| Colorant dispersion (a) | 33.3 parts |
| Glycerin | 20 parts |
| 2-Ethyl-1,3-hexanediol | 2 parts |
| PEG fluorinated alkyl monoether | 2 parts |
| (ZONYL FS 300 from DuPont) | |
| 1-Amino-2-ethyl-2,3-propanediol | 1 parts |
| Distilled water | 33.7 parts |

The mixture is filtered with a membrane filter with pores having a diameter of 0.8 μm, and then vacuum degassed.

Thus an ink (7) is prepared.

### Example 8

The following components are pre-mixed.

| | |
|---|---|
| Pigment Violet 19 (quinacridone) | 150 parts |
| (FASTOGEN SUPER RED 7061B conc. from Dainippon | |
| Ink and Chemicals, Incorporated) | |
| POE (n = 10) β-naphthyl ether phosphate K | 37.5 parts |
| Distilled water | 812.5 parts |

The mixture is subjected to a circular dispersion treatment using a disk-type bead mill (KDL from Shinmaru Enterprise Corporation, media: zirconia ball having a diameter of 0.3 mm) for 20 hours. Thus, a colorant dispersion (b) having an average particle diameter of 83.2 nm is prepared.

The following components are mixed and agitated for 30 minutes.

| | |
|---|---|
| Fluorescent particulate resin dispersion (f1) | 30 parts |
| Colorant dispersion (b) | 12 parts |
| Glycerin | 20 parts |
| 2-Ethyl-1,3-hexanediol | 2 parts |
| PEG fluorinated alkyl monoether | 2 parts |
| (ZONYL FS 300 from DuPont) | |
| 1-Amino-2-ethyl-2,3-propanediol | 1 parts |

The mixture is filtered with a membrane filter with pores having a diameter of 0.8 μm, and then vacuum degassed.

Thus an ink (8) is prepared.

### Comparative Example 5

The procedure for preparing the ink in Example 6 is repeated except that the fluorescent particulate resin dispersion (f1) is replaced with a green fluorescent particulate resin dispersion (LUMIKOL NKW-3202W from Nippon Keiko Kagaku Co., Ltd., having an average particle diameter of 100 nm).

Thus a comparative ink (C5) is prepared.

### Comparative Example 6

The procedure for preparing the ink in Example 6 is repeated except that the fluorescent particulate resin dispersion (f1) is replaced with a pink fluorescent particulate resin dispersion (LUMIKOL NKW-C2117E from Nippon Keiko Kagaku Co., Ltd., having an average particle diameter of 400 nm).

Thus a comparative ink (C6) is prepared.

### Comparative Example 7

The procedure for preparing the colorant dispersion (a) in Example 6 is repeated except that the circular dispersion treatment time is changed to 10 hours. Thus, a colorant dispersion (c) having an average particle diameter of 156.2 nm is prepared.

The procedure for preparing the ink in Example 6 is repeated except that the colorant dispersion (a) is replaced with the colorant dispersion (c).

Thus a comparative ink (C7) is prepared.

### Comparative Example 8

The procedure for preparing the fluorescent particulate resin dispersion (f1) in Example 6 is repeated except that the monomer mixture liquid is dropped in the flask from the separating funnel over a period of 1 hour while gently agitating. Thus, a fluorescent particulate resin dispersion (f3) having an average particle diameter of 126 nm and a standard deviation of 52 nm is prepared.

The procedure for preparing the ink in Example 6 is repeated except that the fluorescent particulate resin dispersion (f1) is replaced with the fluorescent particulate resin dispersion (f3).

Thus a comparative ink (C8) is prepared.

### Comparative Example 9

The procedure for preparing the ink in Example 6 is repeated except that the amounts of the fluorescent particulate resin dispersion (f1) and the colorant dispersion (a) are changed to parts and 40 parts, respectively.

Thus a comparative ink (C9) is prepared.

### Comparative Example 10

The procedure for preparing the ink in Example 6 is repeated except that the amounts of the fluorescent particulate resin dispersion (f1) and the colorant dispersion (a) are changed to 30 parts and 8 parts, respectively.

Thus a comparative ink (C10) is prepared.

### Evaluation 2

Each of the inks (6) to (8) and (C5) to (C10) prepared above is set in a piezo ink-jet printer EM-930C (from Seiko Epson Corporation) and a thermal ink-jet printer DESKJET 880C (from Hewlett-Packard Development Company, LP), respectively, and images are printed on plain paper (X-4024).

The image density and color saturation of the image printed on the plain paper by the piezo ink-jet printer EM-930C is measured with an X-RITE densitometer. The color saturation is defined as a distance between the origin point and a chromaticity (i.e., a* value and b* value) of a solid image measured with the X-RITE densitometer in the chromaticity diagram.

Next, a test pattern of a solid image having an image proportion of 5% is printed on 200 sheets of A4-size plain paper by the piezo ink-jet printer EM-930C and the thermal ink-jet printer DESKJET 880C, respectively. The 200^{th} solid image is observed with a loupe to evaluate the number of white lines and low-density lines caused by image bending.

The evaluation results are shown in Table 2, and the measured chromaticity are shown in Table 3.

TABLE 2

| | Color | Image | Number of Image Bending | |
|---|---|---|---|---|
| | Saturation | Density | EM-930C | DESKJET 880C |
| Ex. 6 | 64.3 | 1.08 | 0 | 0 |
| Ex. 7 | 63.5 | 1.06 | 0 | 0 |
| Ex. 8 | 63.9 | 1.05 | 0 | 0 |
| Comp. Ex. 5 | 52.8 | 1.10 | 0 | 0 |
| Comp. Ex. 6 | 63.0 | 1.03 | 43 | 27 |
| Comp. Ex. 7 | 63.2 | 1.05 | 9 | 6 |
| Comp. Ex. 8 | 64.1 | 1.08 | 5 | 5 |
| Comp. Ex. 9 | 55.1 | 1.09 | 0 | 0 |
| Comp. Ex. 10 | 59.0 | 0.86 | 0 | 0 |

TABLE 3

| | a* value | b* value |
|---|---|---|
| Ex. 6 | 64.2 | −3.7 |
| Ex. 7 | 63.5 | 2.2 |
| Ex. 8 | 63.8 | 2.7 |
| Comp. Ex. 5 | 40.6 | −33.8 |
| Comp. Ex. 6 | 63.0 | −1.8 |
| Comp. Ex. 7 | 63.1 | −3.5 |
| Comp. Ex. 8 | 64.0 | −3.6 |
| Comp. Ex. 9 | 54.8 | −5.4 |
| Comp. Ex. 10 | 59.0 | −0.9 |

This document claims priority and contains subject matter related to Japanese Patent Applications Nos. 2006-216717 and 2006-212887, filed on Aug. 9, 2006 and Aug. 4, 2006, respectively, the entire contents of each of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. An ink-jet ink, comprising:
a pigment;
a dispersant;
a water;
a particulate resin (A) dyed with a fluorescent dye and having an average particle diameter of from 50 to 200 nm; and
an emulsion of a self-emulsifiable polyurethane.

2. The ink-jet ink according to claim 1, wherein the ink-jet ink comprises the particulate resin (A) in an amount of from 0.1 to 40.0% by weight on a solid basis.

3. The ink-jet ink according to claim 1, wherein the self-emulsifiable polyurethane is anionic.

4. The ink-jet ink according to claim 1, wherein the ink-jet ink comprises the polyurethane in an amount of from 0.01 to 7% by weight on a solid basis.

5. The ink-jet ink according to claim 1, wherein the polyurethane has an average particle diameter of not greater than 50 nm.

6. The ink-jet ink according to claim 1, wherein the pigment has an average particle diameter of from 10 to 200 nm.

7. The ink-jet ink according to claim 1, wherein the ink-jet ink comprises the pigment in an amount of from 1 to 15% by weight.

8. The ink-jet ink according to claim 1, wherein the dispersant is a surfactant, and the pigment is dispersed by the surfactant.

9. The ink-jet ink according to claim 8, wherein the surfactant is a nonionic surfactant.

10. The ink-jet ink according to claim 9, wherein the nonionic surfactant is a compound having the following formula (I): 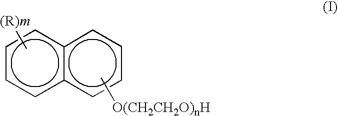
wherein R represents an alkyl, aryl, or an aralkyl group having 1 to 20 carbon atoms, m represents an integer of from 0 to 7, and n represents an integer of from 20 to 200.

11. The ink-jet ink according to claim 10, wherein the compound is a POE (n=40) β-naphthyl ether.

12. The ink-jet ink according to claim 1, further comprising an alkanediol.

13. The ink-jet ink according to claim 1, further comprising an acetylene glycol-based surfactant.

14. An ink-jet ink, comprising:
a particulate resin (A′) dyed with a fluorescent dye and having an average particle diameter of from 50 to 130 nm; and
a quinacridone pigment (B) having an average particle diameter of from 50 to 130 nm,
wherein the particulate resin (A′) has a color tone selected from the group consisting of yellow, yellow-orange, orange, red-orange, red, pink, cerise, rose, magenta, and a mixture thereof.

15. The ink-jet ink according to claim 14, wherein aweight ratio (A′/B) of the particulate resin (A′) to the quinacridone pigment (B) is from 1/2 to 8/1.

16. The ink-jet ink according to claim 14, wherein the particulate resin (A′) has a particle diameter distribution such that a standard deviation is not greater than 40 nm.

17. The ink-jet ink according to claim 14, wherein the particulate resin (A) has at least one monomer unit selected from the group consisting of styrene, acrylonitrile, acrylic acid, and methacrylic acid.

18. The ink-jet ink according to claim 14, wherein the quinacridone pigment (B) is at least one member selected from the group consisting of quinacridone, dimethylquinacridone, and dichloroquinacridone.

19. The ink-jet ink according to claim 14, wherein the ink-jet ink comprises the particulate resin (A′) and the quinacridone pigment (B) in a total amount of from 5 to 20% by weight.

20. The ink-jet ink according to claim 14, wherein the quinacridone pigment (B) is dispersed by a dispersant.

21. The ink-jet ink according to claim 20, wherein the dispersant is a nonionic surfactant.

22. The ink-jet ink according to claim 21, wherein the nonionic surfactant is a POE naphthyl ether.

23. The ink-jet ink according to claim 22, wherein the POE naphthyl ether comprises EO in an amount of from 12 to 60 mol.

24. The ink-jet ink according to claim 20, wherein the dispersant is an anionic surfactant.

25. The ink-jet ink according to claim 24, wherein the anionic surfactant is an alkali metal salt of a POE naphthyl ether phosphate.

26. The ink-jet ink according to claim 25, wherein the alkali metal salt of a POE naphthyl ether phosphate comprises EO in an amount of from 5 to 60 mol, and the alkali metal is at least one member selected from the group consisting of Li, Na, and K.

27. The ink-jet ink according to claim 20, wherein a weight ratio (B/dispersant) of the quinacridone pigment (B) to the dispersant is from 1/1 to 1/0.1.

28. An ink cartridge, detachably attachable to an image forming apparatus, comprising:
a container; and
the ink-jet ink according to claim 1 which is contained in the container.

29. The ink cartridge according to claim 28, wherein the image forming apparatus is an ink-jet printer.

30. An image forming method, comprising:
discharging the ink-jet ink according to claim 1 from a nozzle of an ink-jet printer to form an image on a recording material.

31. The image forming method according to claim 30, wherein the ink-jet printer is a piezo ink-jet printer.

32. The image forming method according to claim 30, wherein the ink-jet printer is a thermal ink-jet printer.

33. An image formed on a recording material with the ink-jet ink according to claim 1.

34. The image according to claim 33, wherein the recording material is a paper.

35. An ink cartridge, detachably attachable to an image forming apparatus, comprising:
a container; and
the ink-jet ink according to claim 14 which is contained in the container.

36. The ink cartridge according to claim 35, wherein the image forming apparatus is an ink-jet printer.

37. An image forming method, comprising:
discharging the ink-jet ink according to claim 14 from a nozzle of an ink-jet printer to form an image on a recording material.

38. The image forming method according to claim 37, wherein the ink-jet printer is a piezo ink-jet printer.

39. The image forming method according to claim 37, wherein the ink-jet printer is a thermal ink-jet printer.

40. An image formed on a recording material with the ink-jet ink according to claim 14.

41. The image according to claim 40, wherein the recording material is a paper.

42. A method for preparing an ink-jet ink, comprising:
adding an aqueous emulsion of a self-emulsifiable polyurethane to a pigment dispersion comprising a pigment, a dispersant, and a water, to prepare a first mixture;
agitating the first mixture;
adding a particulate resin (A) dyed with a fluorescent dye and having an average particle diameter of from 50 to 200 nm to the first mixture, to prepare a second mixture;
agitating the second mixture; and
optionally adding an additive selected from the group consisting of a humectant, a surfactant, an antifoamer, a smear prevention agent, a pH buffering agent, and an antiseptic agent.

43. An ink-jet ink, prepared by the method according to claim 42.
